(19) United States
(12) Patent Application Publication
(10) Pub. No.: US 2005/0083812 A1
(43) Pub. Date: Apr. 21, 2005

(54) Information recording method and information recording medium

(76) Inventors: Harukazu Miyamoto, Higashimurayama (JP); Toshimichi Shintani, Kodaira (JP); Junko Ushiyama, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/879,052

(22) Filed: Jun. 30, 2004

(30) Foreign Application Priority Data
Oct. 15, 2003 (JP) 2003-354491

(51) Int. Cl. G11B 5/58; G11B 7/00

(52) U.S. Cl. 369/53.2; 369/53.37

(57) ABSTRACT

Disclosed here is a phase-change recording medium that can solve a conventional problem that high speed overwriting is difficult due to the limitation of the crystallization speed. A linear velocity range (low speed side) usable for recording by overwriting and a linear velocity range (high speed side) usable for write-once recording are written in a predetermined area on the recording medium and the subject system selects either the overwriting or write-once recording according to the linear velocity. The method can thus realize high speed recording easily and less expensively. And, any conventional medium usable only at low linear velocities can be used as is for high speed recording.

### CROSS REFERENCE

U.S. patent application Ser. No. 10/773,404 is a co-pending application of the present application.

### CLAIM OF PRIORITY

The present application claims priority from Japanese application JP 2003-354491 filed on Oct. 15, 2003, the content of which is hereby incorporated by reference into this application.

### FIELD OF THE INVENTION

The present invention relates to an information recording method for recording information and a medium for the same, more particularly to a high speed recording method for recording information at a high data rate and a medium for the same.

### BACKGROUND OF THE INVENTION

At first, an example of a conventional optical recording/reproducing system will be described with reference to FIG. 7.

FIG. 7 is a block diagram of the conventional optical recording/reproducing system. A light beam irradiated from a laser beam source 25 that is part of a head 2 is collimated into almost a parallel light beam 22 through a collimating lens 24. The light beam 22 is then irradiated on an optical disk 11 through an objective lens 23 to form a spot 21 thereon. After that, the light beam 22 is led into a servo detector 26 and a signal detector 27 through a beam splitter 28, a hologram element 29, etc. Signals from each of those detectors are subjected to an addition/subtraction process to be converted to such servo signals as tracking error signals and focusing error signals, then inputted to a servo circuit respectively. The servo circuit controls the positions of the objective lens 31 and the optical head 2 entirely according to those tracking and focusing error signals to position the beam spot 21 in the target recording/reproducing area. The addition signal of the detector 27 is inputted to a signal reproducing block 41. The input signal is then subjected to a filtering process and a frequency equalizing process in a signal processing circuit to be converted to a digital signal. The digital signal is then processed by an address detection circuit and a demodulation circuit respectively. A microprocessor obtains the position of the beam spot 21 on the optical disk 11 by calculation according to the address signal detected by the address detection circuit to control an automatic position controlling means so as to position the optical head 2 and the beam spot 21 in the target recording unit area (sector).

If the microprocessor is instructed to record data from a host system, the microprocessor receives the data to record from the host system and stores the data in a memory and controls the automatic position controlling means to position the beam spot 21 in the target recording area. The microprocessor then checks if the beam spot 21 is positioned in the target area normally according to the address signal from the signal reproducing block 41. If the beam spot 21 is positioned normally, the microprocessor controls the laser driver, etc. to record the data read from the memory in the target recording area.

If an optical disk medium is loaded in the optical recording system as described above, the optical disk system reads the medium control information (control data) recorded beforehand in a specific area (the lead-in part inside the user area in DVD) on the medium at first. The optical disk system then extracts such waveform information as the medium recording linear velocity, the recording power, the recording pulse width, etc. from the control data and controls the disk rotation speed according to the linear velocity information read from the control data to record/reproduce actual data thereon/therefrom.

FIG. 13 shows a relationship between a recording linear velocity and write/read characteristics (jitter) of a phase-change recording medium (wavelength 405 nm/NA0.85) loaded in a recording system as shown in FIG. 7. The characteristics are satisfactory enough (jitter; about 6%) between the linear velocities 5 m/s and 15 m/s. However, the jitter rises sharply at high speed recording over 20 m/s.

The jitter rising is caused as follows. In the case of phase-change recording, the amorphous making by quick-cooling and crystallization by slow-cooling occur reversibly in the phase-change recording. This phenomenon is used for overwriting. When in high speed recording at a high linear velocity, however, the beam spot moves fast on the medium, so that the “slow-cooling” does not work so effectively, resulting in insufficient crystallization. This is why the amorphous information recorded before is not erased completely. In other words, because the crystallization speed is limited, high speed recording (overwriting) has been considered impossible.

As described above, in the conventional phase-change recording medium, high speed overwriting, that is, high speed recording has been considered impossible due to such a limit of the crystallization speed of the phase-change medium. This has been a conventional problem.

### SUMMARY OF THE INVENTION

Under such circumstances, it is an object of the present invention to solve the above described conventional problem, thereby providing a method for recording/reproducing information on/from a phase-change recording medium at a high speed and the information recording medium itself.

In order to achieve the above object of the present invention, the following means are employed.

(1) The information recording method of the present invention for recording user information on the above recording medium uses at least first and second writing modes. The first writing mode is used as an overwriting while the second writing mode is used as a write-once mode. Either of the two writing modes is selected according to the subject recording speed for recording user information.

This is why both requirements of high speed recording and sure recording are satisfied. For example, if a recording medium having the characteristic shown in FIG. 2 is used, its linear velocity for enabling overwriting is between 5 m/s and 15 m/s. If the medium is used as a write-once type one and information is recorded in a non-recorded area thereon, the recording characteristic is improved up to a linear velocity of 30 m/s or over. This means that if high speed recording is done in the write-once mode and low speed recording is done only for overwriting, both sure overwriting and high speed recording come to be satisfied.

(2) This is why the present invention can control recording so that the first writing mode and the second writing mode are changed over as needed and the change-over information is recorded in a predetermined area on the medium.

Because which of the two recording modes has been used (to be used) is always recorded on the medium as described above, a proper recording mode is always selected even when the medium is used in another drive. And, this makes it possible to improve the interchangeability of the medium. For example, it is avoided to make overwriting in an area already recorded in a mode by mistake. The reliability of the interchangeability is thus assured.

A physical characteristic of the phase-change recording film may be used at a boundary between the first writing mode (overwriting) and the second writing mode (write-once). In other words, because the linear velocity 15 m/s is a limit of the crystallization speed, that is, a limit of physical overwriting type recording speed in the example shown in FIG. 2, the linear velocity 15 m/s may be employed as a boundary between the overwriting mode and the write-once mode.

(3) A first area and a second area are set on the information recording medium. The first area is used for the first recording mode and the second area is used for the second writing mode. And, the set information of each of the first and second areas is recorded in a predetermined area.

This makes it possible to select a proper writing mode more accurately and to enable two types of recording areas, that is, both of the write-once area and the overwriting area to exist together on one recording medium. Therefore, for example, it comes to be possible to record such management information as file system information in the overwriting mode and such archive information as texts and E-mails in the write-once mode, thereby increasing the number of application types to be used.

(4) Part or whole of the area of the medium is set for the first writing mode or second writing mode and the definition information is set in a formatting or initialization processing to be executed before the medium begins to be used.

Consequently, the user comes to be able to select whether to use each medium as an overwriting type one or high speed write-once type one. The user can thus use the medium more conveniently. In addition, the medium manufacturer can reduce the medium manufacturing cost, since the manufacturer is not required to manufacture two types of media.

(5) In another aspect, the method for recording information on the information recording medium has at least first and second writing modes. The first writing mode is an overwriting mode and the second writing mode is a write-once mode. According to this method, at least management information is recorded in a predetermined position on the medium. The management information denotes part or whole of the recording area on the medium is “recorded”, “not recorded”, or “erased”. Consequently, the user can manage the recording area more flexibly, thereby the convenience for using the medium is improved.

(6) When recording information in the “recorded” area, the first mode (overwriting) is used. When recording information in the “not recorded” or “erased” area, the second writing mode is used.

Consequently, the user can record information in the overwriting mode while the high speed recording performance in the archive recording at a high speed specially is improved. Usually, archive recording is done as the first one in each unrecorded area. The above effect is thus expected.

(7) Information erasing is done from an unused area included in the “recorded” area during an idle time in which no user information is recorded nor reproduced and “unrecorded/erased” is set as the management information for the erased area.

The recording medium can thus be used easily just like ordinary disks while high speed recording is done without making the user conscious of it. In other words, the disk performance from the viewpoint of the user is improved practically just like high speed write-once type disks.

(8) In one aspect, the information recording medium of the present invention, which has a phase-change type recording film, records a linear velocity range for enabling normal overwriting and a linear velocity range for enabling write-once recording of information in a predetermined area thereon.

Consequently, the recording system can change over the writing mode between the write-once mode and the overwriting mode easily. In other words, the recording system is not required to check the characteristic of the recording medium each time. The linear velocity ranges may be recorded by the disk manufacturer before the delivery or a result of learning in the subject recording system may be saved in a drive-dedicated area. And, the linear velocity ranges may also be recorded as such ROM information as embossed pits in the control data area in the disk manufacturing process.

(9) The linear velocity range for enabling write-once recording of information is wider than that for enabling overwriting of information. Therefore, the writing performance in the write-once mode that requires the highest recording performance is improved.

(10) In another aspect, the recording medium of the present invention is a disk-like information recording medium having a phase-change recording film. And, in a predetermined area of the medium are recorded at least the disk rotation speed when in recording, the position information for user information overwriting area, the position information for user information write-once recording area. Consequently, the medium is controlled according to a linear velocity to be determined by the disk rotation speed and the head position in the disk radius is made easily. For example, the medium is controlled easily for controlling the high speed CAV (Constant Angular Velocity) in which the disk rotation speed is fixed.

(11) The overwriting area is disposed inside the write-once recording enabled area. Consequently, the medium is used easily as a CAV one and the management information is written in the overwriting area located in the inner area and the outer area is used as a write-once area selectively.

After completing the present invention, an investigation has been done for well-known examples that might be related to the present invention and found JP-A No.259575/9. This document describes a technique for using a logical block address located in the inner portion as an overwriting area and file management information is written there and its outer area as a write-once recording area in which user data is recorded. According to the technique described in the document, however, file management information is recorded in an overwriting area and user data is recorded in a write-once area. The document never describes the technique described in this specification, which changes over the writing mode between an overwriting mode and a write-once mode when in recording user data.

Consequently, both of the two writing modes (the write-once mode and the overwriting mode) are realized on one medium, so that the convenience for using the medium is more improved. And, because the high speed recording characteristic of the medium can be used to the utmost limit in the write-once mode, the practical effect of the recording/transfer speed is improved under the actual use conditions. Especially, the application of the present invention makes it possible to realize high speed recording even when any of conventional media for enabling only for low linear velocity recording is used as is, thereby enabling high speed recording more easily and less expensively.

### BRIEF DESCRIPTION OF THE DRAWINGS

FIG. 1 is a flowchart for controlling a recording method of the present invention;

FIG. 2 is a graph for denoting the recording/reproducing characteristics of a recording medium in an embodiment of the present invention;

FIG. 3 is an illustration for denoting an example of the recording medium in the embodiment of the present invention;

FIG. 4 is a block diagram of a recording system in the embodiment of the present invention;

FIG. 5 is a structure of control data in the embodiment of the present invention;

FIG. 6 is a table for describing principles of the embodiment of the present invention;

FIG. 7 is a block diagram of a conventional recording system in an embodiment;

FIG. 8 is a graph for denoting an example of recording/reproducing characteristics in a mode of the recording medium in the embodiment of the present invention;

FIG. 9 is a graph for denoting an example of recording/reproducing characteristics in a write-once mode of the recording medium in the embodiment of the present invention;

FIG. 10 is a graph for denoting a recording strategy in a mode in the embodiment of the present invention;

FIG. 11 is a graph for denoting a recording strategy in the write-once mode in the embodiment of the present invention;

FIG. 12 is a graph for denoting the characteristics of the recording medium in the embodiment of the present invention;

FIG. 13 is a graph for denoting the recording/reproducing characteristic of the conventional recording medium; and

FIG. 14 is a graph for denoting the characteristics of the recording medium in the embodiment of the present invention.

### DETAILED DESCRIPTION OF THE PREFERRED EMBODIMENTS

[First Embodiment]

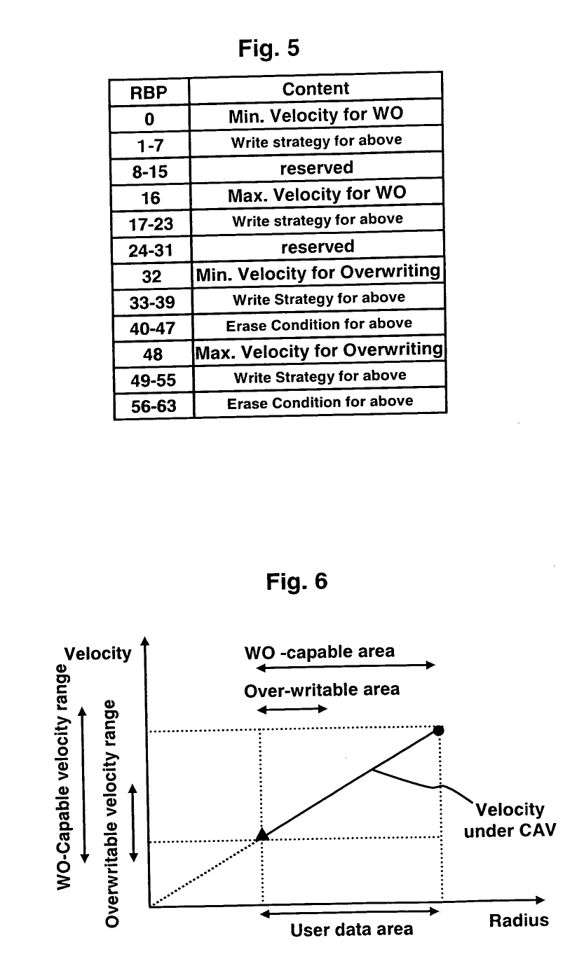

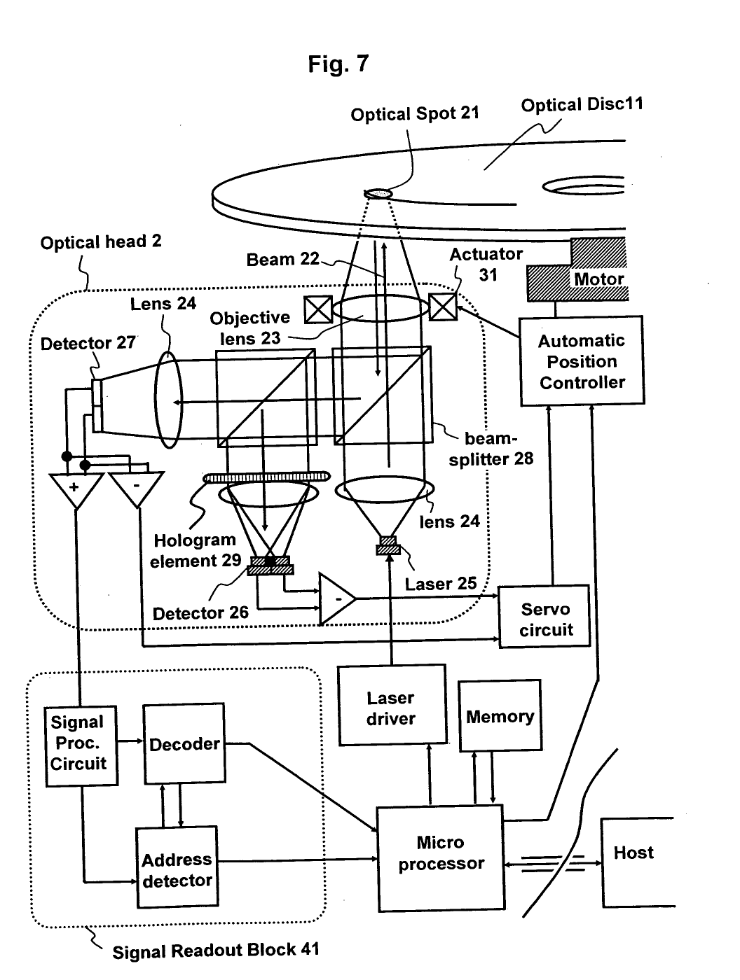

FIG. 3 is an explanatory view of recording areas on a recording medium 1 in this first embodiment of the present invention. A write-once (WO) area 111 is provided at an outer periphery portion of the disk-like recording medium 1 while the first/last address of each area is recorded in a control data area 121 located at an inner lead-in part. In this disk control information part is also recorded information related to the disk rotation speed. FIG. 5 is an extracted area in which linear velocity information of the control data is recorded.

The RPB denotes a relative byte position. Each item in this table is represented by one byte, that is, 8 bits. In the fields of PBR=0 and PBR=16 are written the minimum and maximum linear velocity information in the write-once mode and in the fields of RBP=32 and RBP=48 are written the minimum and maximum linear velocity information in the overwriting mode.

In the recording medium in this first embodiment, 5 m/s is written as the minimum linear velocity in the write-once mode, 30 m/s is written as the maximum linear velocity in the write-once mode, 5 m/s is written as the minimum linear velocity in the overwriting mode, and 15 m/s is written as the maximum linear velocity in the overwriting mode.

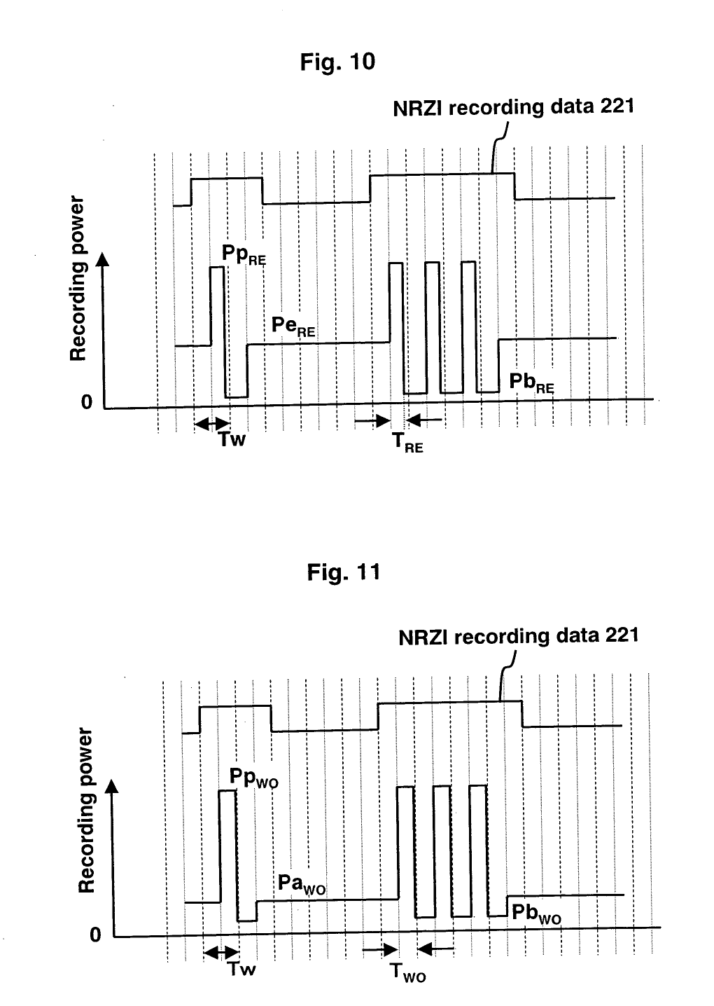

In the fields of RBP=1 to RBP=7 are written recording pulse information at the minimum linear velocity in the write-once mode. The recording strategy (parameter) differs between the write-once mode and the overwriting mode. FIG. 11 shows the recording waveform in the write-once mode and FIG. 10 shows the recording wave in the overwriting mode. Information items of those pulse widths T_{wo}, T_{RE}), recording powers (P_{pwo}, P_{PRE}), an erasing power (Pe_{RE}), an auxiliary recording power (Pa_{wo}), bottom powers (Pb_{wo}, Pb_{RE}), etc. are written as control data. In the write-once mode, in addition to the recording waveforms, a DC erasing condition (PeDC) is also written. This method corresponds to the above means that combines both “erasing” and “recording” without overwriting to speed up the operation practically.

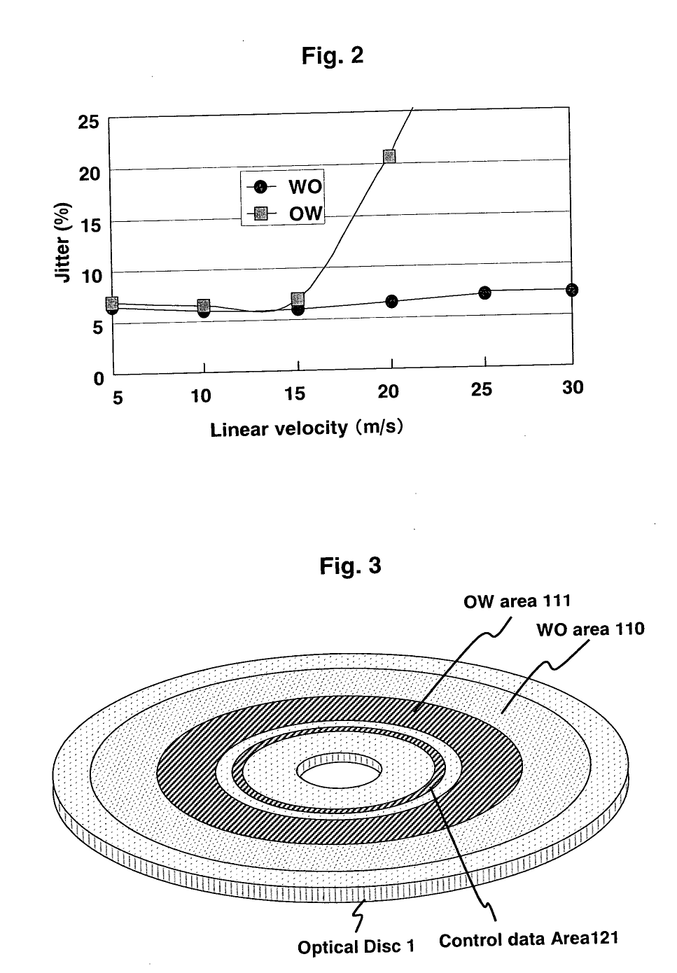

FIG. 2 shows the dependency of the reproduced signal quality (jitter) on the recording linear velocity of the medium in this embodiment. The recording characteristic of the recording film of this medium is practically equal to that of the conventional recording medium.

As shown in FIG. 2, the recording characteristic is favorable between 5 m/s equivalent to the standard linear velocity and 15 m/s equivalent to the 3-time linear velocity. When the linear velocity exceeds 15 m/s, however, the jitter becomes worse. In other words, the usable linear velocity range is between 5 m/s and 15 m/s in the overwriting mode. On the other hand, when information is recorded just once in an unrecorded area, that is, in the write-once mode, the recording characteristic is favorable up to a linear velocity of 30 m/s. Concretely, the recording medium can satisfy both of sure overwriting and high speed recording if the write-once mode is used for recording over a linear velocity of 15 m/s and the low linear velocity is used only when overwriting is required.

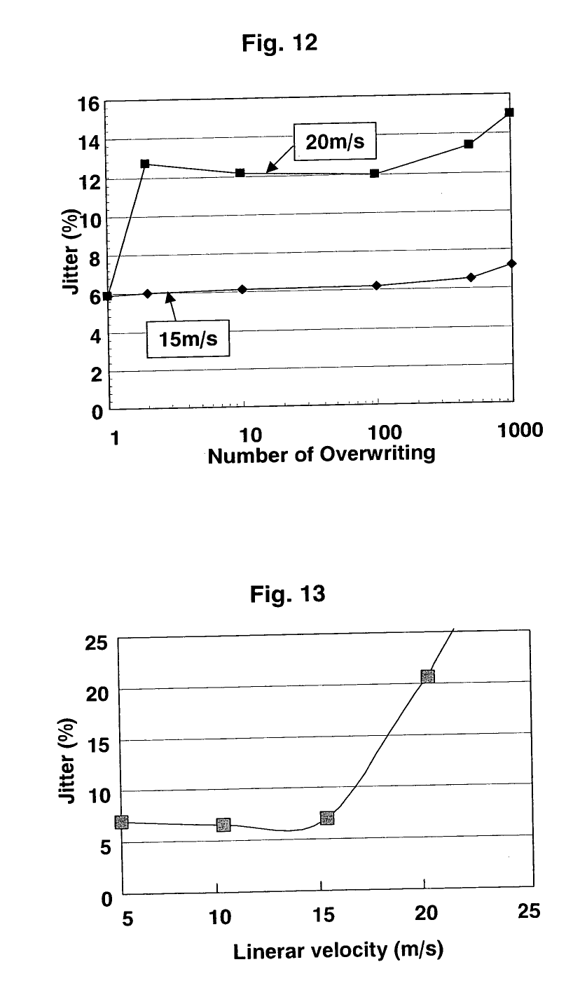

FIG. 12 denotes the dependency of the recording medium on the number of overwriting times at linear velocities of 15 m/s and 20 m/s, as well as on the jitter. At 20 m/s, the jitter is suppressed low only for the first time recording. However, the recording jitter rises significantly after that. On the contrary, the recording jitter does not change almost at all in overwriting even when it is repeated at 15 m/s. This means that overwriting is assured at a low linear velocity while the jitter rises only for the first time recording at a high linear velocity.

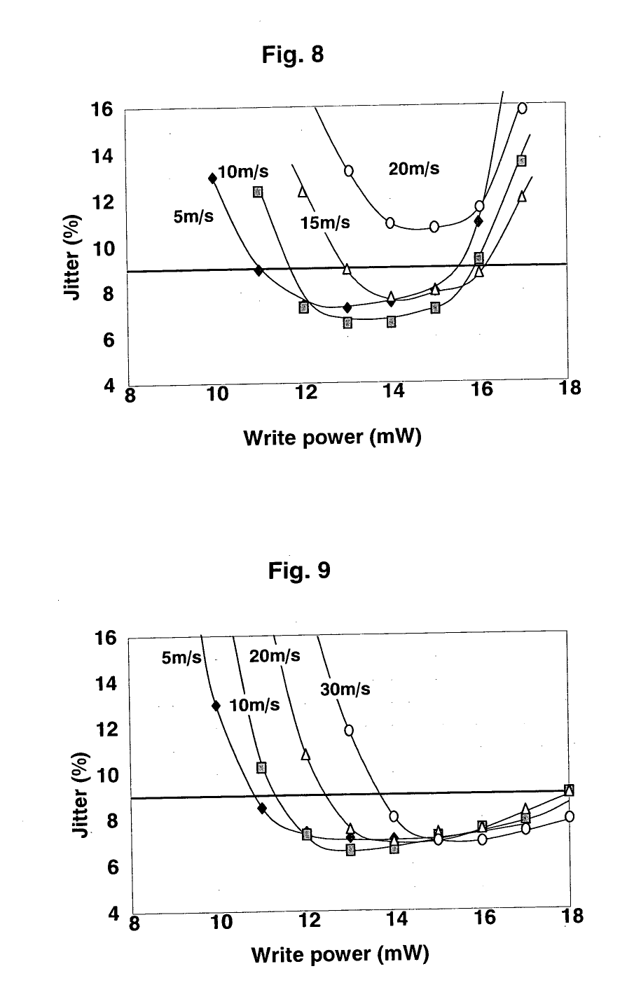

FIGS. 8 and 9 show the dependency of the recording power margin of this recording medium on the linear velocity. In the write-once mode (FIG. 9), a power margin is over 4 mW even at 20 m/s. On the other hand, in the overwriting mode (FIG. 8), the jitter rises as high as 11% at 20 m/s. However, a practical level power margin is kept up to a linear velocity of 15 m/s.

[Second Embodiment]

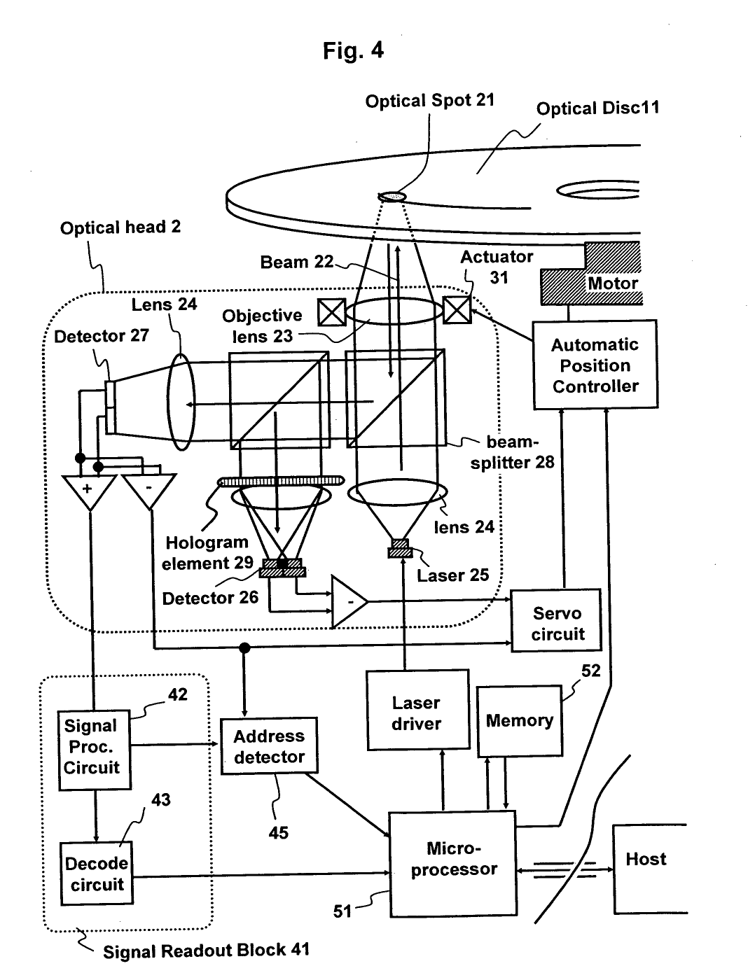

Hereunder, an example of an optical recording system of the present invention will be described with reference to FIG. 4.

FIG. 4 is a block diagram of the optical recording system of the present invention. A light beam irradiated from a laser beam source 25 (wavelength: about 405 nm), which is part of a head 2, is collimated into almost a parallel light beam 22 through a collimating lens 24. The light beam 22 is then irradiated on an optical disk 11 through an objective lens 23 having a numerical aperture of 0.85 to form a spot 21 there. After that, the light beam 22 is led into a servo detector 26 and a signal detector 27 through a beam splitter 28, a hologram element 29, etc respectively. Signals from each of those detectors are subjected to an addition/subtraction process to be converted to such servo signals as tracking error signals and focusing error signals, then inputted to a servo circuit. The servo circuit controls the positions of the objective lens 31 and the optical head 2 entirely according to those tracking and focusing error signals to position the beam spot 21 in the target recording/reproducing area. The addition signal of the detector 27 is inputted to a signal reproducing block 41. The input signal is then subjected to a filtering process and a frequency equalizing process in a signal processing circuit 42 to be converted to a digital signal. The digital signal is then processed by a demodulation circuit 43. Although address information is obtained from a wobble signal in an address detection circuit 45, a recording information reproducing signal obtained from a sum signal is also used together with the wobble signal to improve the reliability of the address detection in this embodiment. The wobble signal is obtained from a differential output from the detector 27.

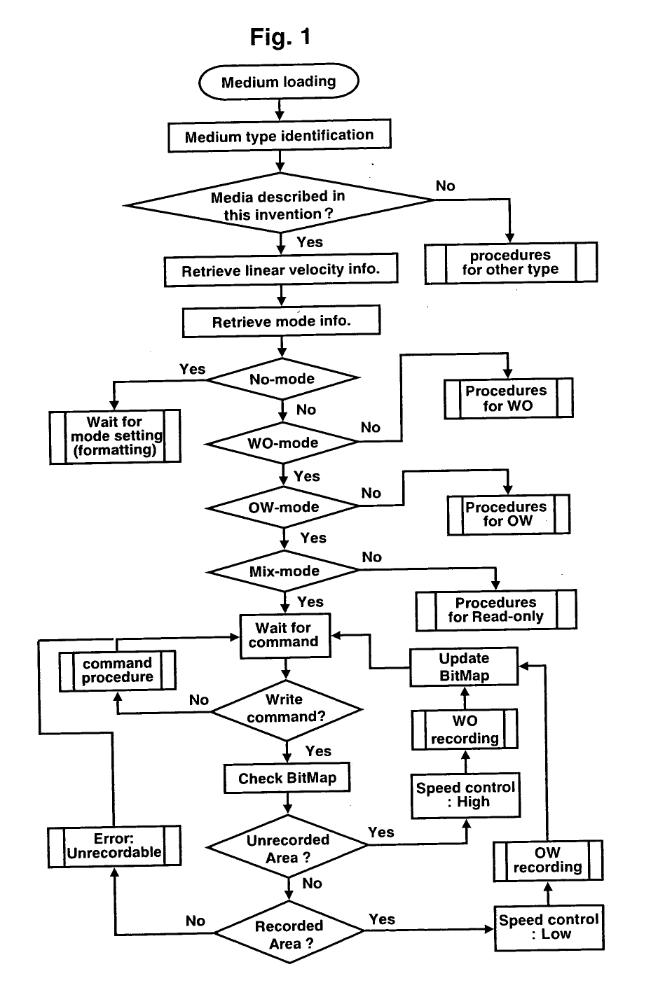

Hereunder, a description will be made for an operation flow of the recording system of the present invention with reference to FIG. 1. If a disk is loaded into the optical recording system or the optical recording system is powered, the optical recording system identifies the disk type at first. In addition to the high speed high density recording media corresponding to a blue light source, the recording system of the present invention can also record/reproduce information on/from CD and DVD media. This is why the optical recording system identifies the loaded medium type among the media mentioned above. While how to identify such a medium type differs among systems, the recording system in this embodiment checks the medium type roughly from the reflection rate and the analog characteristic of such a reproduced signal as a focusing error signal to control the gain, etc., then reproduces a light spot on a physical information area of the medium (control data) provided on the disk substrate to decide the medium type finally according to the obtained data.

If the medium of the present invention is loaded in the recording system at that time, the system obtains the linear velocity information from the control data, then stores the information in a memory 52 (FIG. 4). The system then reproduces the recording mode information from the recording medium. The recording mode information is recorded in the recording management area on the medium and the area itself enables information stored therein to be overwritten. A microprocessor 51 determines the usable linear velocity corresponding to the recording mode according to the stored linear velocity information to control the disk rotation. In the case of the recording medium in this embodiment, which corresponds to both overwriting and write-once modes, the recording area on the medium is managed in a bit map pattern. The bit map denotes that the subject area is a recorded area or unrecorded area. The description in this bit map differs from information for denoting whether or not an area used in a general file system is being used. In other words, an area in which information is recorded once is managed as a recorded area in the recorded bit map even after the information in the area is not used any more and the area is thus regarded as an unrecorded area in the file system. If a recording command is issued to the recording system in this embodiment, the system refers to the bit map to determine whether or not the target area is a recorded one at first. If no information is recorded in the area, the system rotates the disk at a high speed so as to enable high speed recording in the write-once mode. If information is already recorded in the area, the system enables the recording to be done in the area at a low speed in the overwriting mode. If such a compatible medium as an optical disk is used to archive various types of information, for example, for backing up PC data, almost no overwriting is done actually. Even when the medium enables overwriting, information is usually written just once in an unrecorded area other than the information management area. Therefore, the average transfer speed of the recording medium is improved significantly, since information is recorded only in unrecorded areas in the write-once mode.

[Third Embodiment]

FIG. 6 is an illustration for describing principles of the recording system in another embodiment of the present invention. In this third embodiment, the recording medium is controlled for rotation in the CAV (Constant Angular Velocity) mode in which the rotation speed is fixed. The rotation speed is 4000 rpm. The characteristic of the recording medium is the same as that shown in FIG. 2. Therefore, 5 m/s is recorded as the minimum linear velocity for enabling write-once recording, 30 m/s is recorded as the maximum linear velocity for enabling write-once recording, 5 m/s is recorded as the minimum linear velocity for enabling overwriting, and 15 m/s is recorded as the maximum linear velocity for enabling overwriting in the control data respectively. In other words, both overwriting and write-once recording are possible within a linear velocity between 5 m/s and 15 m/s and only write-once recording is possible within a linear velocity between 15 m/s and 30 m/s.

The innermost periphery of the recording area shown in FIG. 6 is 24 mm in radius and the outermost periphery thereof is 58 mm in radius. The linear velocity is thus 10 m/s at the innermost periphery and 24 m/s at the outermost periphery when the rotation speed is 4000 rpm. Consequently, both of the write-once mode and the overwriting mode are usable at the innermost periphery. At the outermost periphery, however, only the write-once mode is usable. The maximum linear velocity 15 m/s for enabling overwriting is usable at a radius of about 36 mm. In this third embodiment, therefore, an area of about 4 GB up to a logical block address LBA=1EA000 located at a radius of about 32 mm is defined as an overwriting area while an area of about 21 GB outside the 1EA000 is defined as a dedicated write-once area. And, an area up to a logical address 1EA000 is defined as an area for enabling overwriting. Those defined information items are recorded in the recording management area (RMA) on the disk. This area information is sent to a host system to which the recording system is connected through an interface command. The host system manages the area up to a logical address LBA=1EA000 as an overwriting area using a file system driver that is the host system's control software according to this area information. Actually, such management information as file information, directory information, etc. are recorded in the overwriting area and actual files are recorded in an area that follows the logical address of LBA=1EA000. Files can thus be deleted and overwritten just by overwriting the file management information; there is no need to overwrite any file itself. This is why very high speed recording over a linear velocity of 15 m/s is realized in the write-once area in which mass data is often recorded, thereby making the user feel as if he/she was handling a full overwriting type medium. In this third embodiment, because the CAV controlling method that fixes the rotation speed is employed, there is no need to change the disk rotation speed between inner periphery and outer periphery of the disk, thereby the user can access the disk very quickly. In addition, the power consumption is also saved, so that the recording medium of the present invention is suitable for mobile recording systems, especially for lap-top PCs.

[Fourth Embodiment]

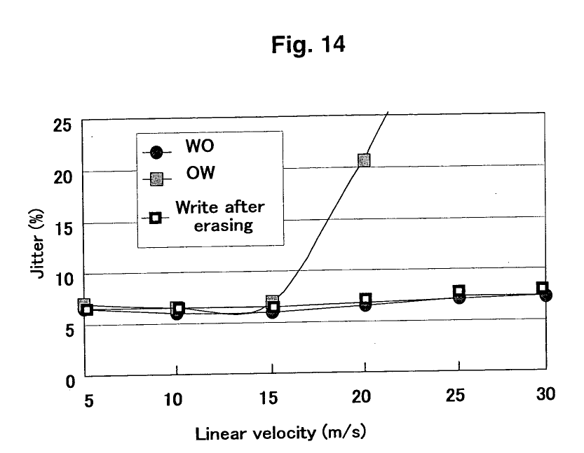

In the second embodiment, write-once recording is made in unrecorded areas. However, as shown in FIG. 14, high speed recording is possible even in once-recorded areas just like in the write-once mode. In this embodiment, once-recorded data is erased logically, then a DC beam is irradiated in the unnecessary area at comparatively a low speed to erase the data actually therefrom. This erasure operation is executed in the background during an idle time in which neither the user nor host system processes a record/reproduce command. To enable this erasure in the background, the host system executes an “erase” command for the unnecessary (logically data erased) area in the recording system. Receiving the “erase” command, the recording system records “a list of areas to be erased” in the management area before executing an erasure operation actually, then erases the data from the area during the next idle time and prepares for the next “record” command. If such an erasure operation is done actually, the recording system deletes the area from the “list of areas to be erased”, then updates the bit map to reset the state of the area from “recorded” to “unrecorded”.

When processing a “record” command, if the state of the target area is “recorded”, the recording system checks if the area is registered in the “list of areas to be erased”. If not registered, the system executes an overwriting operation as usually. If it is registered in the list, the system overwrites information in the area and deletes the area from the “list of areas to be erased” simultaneously. Unless otherwise this deletion is done, the necessary overwritten information might be erased by mistake in the background. This deletion must thus be done before overwriting information there to assure the reliability of the recording medium.

If the state of an area targeted by a “record” command is “unrecorded”, the system executes a high speed write-once processing just like in the second embodiment.

In this embodiment, even an application program used often to overwrite new data on recorded data (in an entire file) can execute a high speed write-once processing by erasing information in the background, thereby the operation easiness is more improved and the average recording speed is more improved than the second embodiment.

While an “erase” command is processed to erase target information in the background in the recording system in this embodiment, the recording system may also execute the “erase” command without erasing the target information in the background so that the host side file system erases the information in the background. In that connection, an idle time of the file system (host system) is used to issue an “erase” command to the recording system as needed in the background. At this time, because the file system can recognize each non-erased area, the system can use each “erased” area, that is, an “unrecorded” area by priority so as to execute the high speed write-once recording more often to speed up the operation.

[Fifth Embodiment]

In this fifth embodiment, it is selected whether the whole disk is used in the write-once mode or in the overwriting mode before the disk is to be used. A recording mode is selected just before the disk is formatted. Such an example of recording mode selection when the disk is formatted is seen in the change-over between the DVD-RW overwriting mode (Restricted Overwrite mode) and the sequential recording mode. In the case of this DVD-RW overwriting mode, information is overwritten directly. In the case of the sequential recording mode, the target area is accessed in the write-once mode; basically, no overwriting is done. In the DVD-RW sequential recording mode, however, the physically low speed overwriting mode is usually used. This is because the state of the target area is not always “unrecorded” before the mode selection, that is, before formatting and the area might be recorded before or the disk check data used before the delivery might be left over therein.

In this embodiment, if a once-recorded disk is formatted again, the disk is basically permitted to record information only in the overwriting mode. If the user wants to record any information in the write-once mode, the user comes to be requested to “erase” the recording area on the disk completely, initializes the disk, format the disk again, and set the write-once mode. After such a re-initialization processing, the user can select either of the following two types of erasure operations; erasing only the necessary portion with use of the bit map or erasing the entire area of the disk as a DC erasure. There is also another method that an optional dedicated initialization device is used to erase information from the entire area of the disk at a high speed. This erasure operation is effective to protect recorded user information from a leakage that might occur at the time of disk recycling. Such disk recycling that uses a dedicated initialization device is also expected to become a business opportunity.

While the present invention has been described in detail with reference to the preferred embodiments, it is to be understood that modifications will be apparent to those is skilled in the art without departing from the spirit of the invention. For example, instead of recording the recording condition corresponding to a linear velocity as control data, the recording condition corresponding to both rotation speed and radius position may be used as control data.

Furthermore, the control information part in which a linear velocity range is recorded beforehand may not necessarily be a reproduction dedicated one. The medium manufacturer may measure a linear velocity range corresponding to the disk and record the corresponding linear velocity range in accordance with the measurement result. And, instead of the medium manufacturer, the recording system itself may obtain a linear velocity range corresponding to each recording mode of the medium by recording/learning it at the first start-up time and record the information in a DIZ (Disk Information Zone) on the recording medium together with the drive ID so as to control the recording mode according to the information recorded in the DIZ when the same medium is loaded in itself.

This specification applies specially to information recording methods and information recording media preferred to high speed recording.

1. An information recording method for recording user information on an information recording medium,
wherein said method includes a first recording mode, which is an OW-type one that overwrites new user information on said recording medium while erasing old user information therefrom and a second recording mode, which is a WO-type one that appends said user information; and
wherein said first recording mode or said second recording mode is selected according to a linear velocity of said recording to record said user information.

2. An information recording method for controlling recording by switching between said first recording mode and said second recording mode to record information of said switching in a predetermined area on said information recording medium.

3. The information recording method according to claim 2,
wherein a first area for recording information in said first recording mode and a second area for recording information in said second recording mode are set on said information recording medium and said set information of said first and second areas is recorded in a predetermined area on said information recording medium.

4. The information recording method according to claim 2,
wherein a first area for recording information in said first recording mode and a second area for recording information in said second recording mode are set on said information recording medium and said set information is recorded in a formatting or initialization process performed before recording of said user information on said information recording medium begins.

5. The information recording method according to claim 1,
wherein said information recording medium has a phase-change recording film; and
wherein a boundary between said first and second recording modes is determined by a physical characteristic of said phase-change recording film.

6. The information recording method according to claim 1,
wherein a CAV recording method is employed for said recording; and
wherein said user information is recorded in said first recording mode at the inner periphery side and in the second recording mode at the outer periphery of said information recording medium respectively.

7. The information recording method according to claim 1,
wherein recording is made in said second recording mode on said information recording medium, then said linear velocity slows down to record information in said first recording mode.

8. An information recording method for recording user information on an information recording medium,
wherein said method includes a first recording mode, which is an OW-type one that overwrites user information on said information recording medium while erasing old user information therefrom and a second recording medium, which is a WO-type one that appends said user information; and
wherein a predetermined position of said information recording medium records management information for denoting whether the state of each recording area of said user information on said information recording medium is “recorded”, “unrecorded”, or “unrecorded or erased”.

9. The information recording method according to claim 8,
wherein said first recording mode is selected to record information in said “recorded” area;
wherein said second recording mode is selected to append information in said “unrecorded or erased” area.

10. The information recording method according to claim 8,
wherein information is erased from an unused area included in said “recorded” area during an idle time in which said user information is not recorded nor reproduced so as to change the management information corresponding to said area to be erased to “unrecorded or erased”.

11. An information recording medium used for recording information on itself,
wherein said information recording medium has a phase-change recording film; and
wherein a predetermined area on said information recording medium records a first linear velocity range for enabling overwriting for recording user information and a second linear velocity range for enabling write-once recording of said user information.

12. The information recording medium according to claim 11,
wherein said second linear velocity range is wider than said first linear velocity range.

13. An information recording medium for enabling information to be recorded thereon,
wherein said information recording medium has a phase-change recording film; and
wherein a predetermined area of said information recording medium records a recording time rotation speed, positional information of a first area for enabling overwriting user information, and positional information of a second area for enabling write-once recording of user information.

14. The information recording medium according to claim 13, wherein said first area is positioned inside said second area on said information recording medium.
